(19) United States
(12) Patent Application Publication
(10) Pub. No.: US 2010/0270089 A1
(43) Pub. Date: Oct. 28, 2010

(54) COMPACT TACTILE INPUT AND OUTPUT APPARATUS

(75) Inventors: Ki Uk Kyung, Daejeon (KR); Il Yeon Cho, Daejeon (KR); Jun Seok Park, Daejeon (KR); Chang Seok Bae, Daejeon (KR); Dong Won Han, Daejeon (KR)

Correspondence Address: AMPACC Law Group, 3500 188th Street S.W., Suite 103, Lynnwood, WA, 98037, US

(73) Assignee: Electronics and Telecommunications Research Institute, Daejeon (KR)

(21) Appl. No.: 12/682,575

(22) PCT Filed: May 19, 2008
(86) PCT No.: PCT/KR08/02774

§ 371 Date: Apr. 9, 2010

(30) Foreign Application Priority Data
Oct. 10, 2007 (KR) 10-2007-0101953

(51) Int. Cl. G06F 3/043

(52) U.S. Cl. 178/18.04

(57) ABSTRACT

An apparatus for transmitting information in the form of a tactile sense is provided. Particularly, a tactile-sense input/output motor and a tactile-sense input/output apparatus using the tactile-sense input/output motor are provided. A tactile-sense input/output housing having a plurality of tactile-sense input/output motors, each of which performs a linear motion according to an ultrasonic electrical signal to transmit a tactile sense to a contact surface and senses a pressure of the contact surface to output a tactile-sense input signal is used for portable apparatuses, wrist wearable devices, rings, or other various apparatuses so as to transmit information through a tactile sense.

### TECHNICAL FIELD

The present invention relates to an interface for transmitting a tactile sense, and more particularly, to a tactile input/output apparatus having a plurality of compact motors for inputting and outputting a tactile sense employed to various electronic apparatuses so as to implement information transmitting in the form of the tactile sense.

The present invention was supported by the IT R&D program of MIC/IITA.[2006-S-032-02: Development of an Intelligent Service Technology based on the Personal Life Log]

### BACKGROUND ART

Various technologies for inputting and outputting information using electronic apparatuses have been developed and provided. In general, a method of inputting information and a method of outputting information are separately provided. As examples of the method of inputting information, there are methods using a keyboard and a mouse of a computer, methods using key pads or a touch screen of a mobile phone, a method using a sound, and the like.

As examples of the method of outputting information, there a method of visually outputting information through a screen of various electronic products such as a computer, a mobile phone, and a TV, a method of aurally outputting information though a speaker, and a method of visually and aurally outputting information. In a case where information is transmitted by using only one of auditory and visual senses, the information may not sufficiently transmitted according to states of persons which transmit and receives the information and characteristics of the information.

For example, a blind person cannot receive information through the visual sense, and a deaf person cannot receive information through the auditory sense. Recently, in order to solve the problem, technologies for transmitting information through tactile sense have been actively developed. In this case, the information can be transmitted by applying a stimulus on a skin of a human body and transmitting the stimulus through the tactile sense. Various methods using the tactile sense such as an electronic braille apparatus for a blind person, a texture transmitting method for transmitting a texture of an object, a vibration apparatus for transmitting information through vibration in a mobile phone have been proposed and used.

However, the conventional methods using the tactile sense are directed to output information to a user which senses the output from a tactile-sense apparatus and perceives the information through comparison with previously-perceived information. That is, any method of inputting information by using the tactile sense has not been proposed.

### DISCLOSURE OF INVENTION

1. Technical Problem

The present invention provides tactile-sense interface capable of inputting and outputting tactile-sense information though the same tactile-sense apparatus.

In addition, the present invention provides a technology capable of implement a compact tactile-sense input/output motor so as to be employed to various apparatuses and a technology capable of integrating a sensor of sensing tactile-sense input into the compact tactile-sense input/output motor.

2. Technical Solution

According to an aspect of the present invention, there is provided a compact tactile-sense input/output motor comprising: a transducer which generates a displacement according to an electrical signal; a moving shaft which is connected to the transducer to vertically move according to the displacement of the transducer; a moving member which is formed in a shape of surrounding the moving shaft to move according to the electrical signal; a tactile-sense transmitting portion which is provided to an upper surface of the moving member to transmit a tactile sense to a contact surface contacting with a skin according to the movement of the moving member and to transmit a pressure of the contact surface to the moving member so as to move the moving member downwards; and a contact sensor which senses a contact of the downwardly-moving moving member to output a tactile-sense input signal.

In the above aspect of the present invention, the electrical signal may be an electric signal in the ultrasonic frequency band, and the transducer is made of a piezoelectric material.

In addition, the contact sensor may be disposed to the moving shaft between the transducer and the moving member.

In addition, the compact tactile-sense input/output motor may further comprise a contact portion which is formed to a lower surface of the moving member to transmit the movement of the moving member to the contact sensor.

According to another aspect of the present invention, there is provided a compact tactile-sense input/output motor comprising: a transducer which generates a displacement according to a ultrasonic electrical signal; a moving shaft which is connected to the transducer to perform a vertical fine reciprocating motion according to the displacement of the transducer; a moving member which is formed to surround the moving shaft to vertically move according to the reciprocating motion of the moving shaft; a tactile-sense transmitting portion which is provided to an upper surface of the moving member to transmit a tactile sense to a contact surface contacting with a skin according to the movement of the moving member and to transmit a pressure of the contact surface to the moving member so as to move the moving member downwards; and a displacement measurement sensor which measures a moving displacement of the moving member according to the pressure and outputs a tactile-sense input signal if a predetermined moving displacement occurs.

In the above aspect of the present invention, the displacement measurement sensor may comprise: a moving pin fixed on a lower surface of the moving member; and an electricity inducing unit which outputs the tactile-sense input signal according to a change in current and voltage generated according to the moving displacement of the moving pin.

According to another aspect of the present invention, there is provided a compact tactile-sense input/output motor comprising: a transducer which generates a displacement according to an electrical signal; a moving shaft which is connected to the transducer to vertically move according to the displacement of the transducer; a moving member which is formed in a shape of surrounding the moving shaft to move according to the electrical signal; a tactile-sense transmitting portion which is provided to an upper surface of the moving member to transmit a tactile sense to a contact surface contacting with a skin according to the movement of the moving member and to transmit a pressure of the contact surface to the moving member so as to move the moving member downwards; and an optical sensor which measures a moving displacement of a moving pin fixed on a lower surface of the moving member by using a light and outputs a tactile-sense input signal.

In the above aspect of the present invention, the optical sensor may comprise: a light-emitting unit which emits a light; and a light-receiving unit which senses a change of the light emitted by the light-emitting unit according to the moving displacement of the moving pin to output the tactile-sense input signal.

According to another aspect of the present invention, there is provided a compact tactile-sense input/output motor comprising: a transducer which generates a displacement according to an electrical signal; a moving shaft which is connected to the transducer to perform a vertical movement according to the displacement of the transducer to transmit a tactile sense to a contact surface contacting with a skin and to move downwards according to the a pressure of the contact surface; a moving member which is formed to surround the moving shaft and fixed on the contact surface contacting with the skin; and a sensor which measures a moving displacement of the moving shaft according to the pressure and outputs a tactile-sense input signal if a pre-determined moving displacement occurs.

In the above aspect of the present invention, the sensor may sense a contact of the transducer moving downwards according to the movement of the moving shaft according to the pressure and outputs the tactile-sense input signal. In addition, the sensor may output the tactile-sense input signal when the contact is sensed according to the downward movement of the moving pin connected to the moving shaft.

According to another aspect of the present invention, there is provided a tactile-sense input/output apparatus comprising: a tactile-sense input/output housing having a plurality of tactile-sense input/output motors, each of which performs a linear motion according to an ultrasonic electrical signal to transmit a tactile sense to a contact surface and senses a pressure of the contact surface to output a tactile-sense input signal; a power supplying unit which supplies a power to the plurality of the tactile-sense input/output motors; a controller which controls the electrical signals input to the ultrasonic input/output motors and receives the tactile-sense input signals; and a transceiver which receives the control signals for the tactile-sense input/output motors to transmit the control signals to the controller and transmits the tactile-sense input signal.

In the above aspect of the present invention, the aforementioned tactile-sense input/output motors can be used for the tactile-sense input/output apparatus.

In addition, lengths of moving shafts of adjacent tactile-sense input/output motors of the tactile-sense input/output housing may be different from each other so that the tactile-sense input/output motors are arrayed in an overlapped form.

In addition, the tactile-sense input/output apparatus can be used as information input/output apparatus employed to various electronic products.

The tactile-sense input/output apparatus can be built in as data input/output apparatus using the tactile sense for a mobile phone, a remote controller, or a ring.

According to another aspect of the present invention, there is provided a method of inputting and outputting a tactile sense in a tactile-sense input/output motor which performs a linear motion according to an ultrasonic electrical signal to transmit a tactile sense to a contact surface and senses a pressure of the contact surface to output a tactile-sense input signal, the method comprising: applying an electrical signal to the tactile-sense input/output motor; measuring a movement of a moving shaft of the tactile-sense input/output motor, the movement being generated by the transmitted pressure; stopping applying of the electrical signal when the moving shaft is moved to a predetermined position; and outputting the tactile-sense input signal when the moving shaft contacts with a sensor of the tactile-sense input/output motor.

### ADVANTAGEOUS EFFECTS

As described above, according to a compact tactile-sense input/output motor and a tactile-sense input/output apparatus of the present invention, it is possible to output and input tactile-sense information by using the same apparatus.

In addition, it can be checked whether or not information is accurately input through a tactile sense, and a result of the checking can be output through the tactile sense in real-time, so that it is possible to accurately transmit information through the tactile sense.

### BRIEF DESCRIPTION OF THE DRAWINGS

FIG. 1 is a view for explaining a principle of a linear actuator used for the present invention.

FIG. 2 is a view illustrating a method of attaching a pin-type tactile-sense transmitting portion to the linear actuator used for the present invention.

FIG. 3 is a view illustrating a first embodiment of a compact tactile-sense input/output motor attached with a sensor for sensing a tactile-sense input according to the present invention.

FIG. 4 is a view illustrating a second embodiment of a compact tactile-sense input/output motor attached with a sensor for sensing a tactile-sense input according to the present invention.

FIG. 5 is a view illustrating a third embodiment of a compact tactile-sense input/output motor attached with a sensor for sensing a tactile-sense input according to the present invention.

FIG. 6 is a view illustrating a fourth embodiment of a compact tactile-sense input/output motor attached with a sensor for sensing a tactile-sense input according to the present invention.

FIG. 7 is a view illustrating a concept of inputting a tactile sense by using a moving shaft according to the present invention.

FIG. 8 is a view illustrating a first embodiment of a compact tactile-sense input/output motor of inputting and outputting a tactile sense by using a moving shaft according to the present invention.

FIG. 9 is a view illustrating a second embodiment of a compact tactile-sense input/output motor of inputting and outputting a tactile sense by using a moving shaft according to the present invention.

FIG. 10 is a view illustrating a construction of a tactile-sense input/output housing in which a plurality of compact tactile-sense input/output motors are arrayed uniformly, according to the present invention.

FIG. 11 is a view illustrating a construction of a tactile-sense input/output apparatus according to the present invention.

FIG. 12 is a view illustrating an embodiment of a tactile-sense input/output apparatus applied to a portable apparatus, according to the present invention.

FIG. 13 is a view illustrating an embodiment of a tactile-sense input/output apparatus built in a remote controller or a wrist wearable device, according to the present invention.

FIG. 14 is a view illustrating an embodiment of a tactile-sense input/output apparatus built in a ring, according to the present invention.

FIG. 15 is a view illustrating a method of inputting a tactile sense for inputting information while feeling the tactile sense, according to the present invention.

FIG. 16 is a view illustrating a method of using a tactile-sense input/output housing as a plurality of input buttons, according to the present invention.

FIG. 17 is a view illustrating an example of employing a tactile-sense reproducing button, according to the present invention.

FIG. 18 is a view illustrating an output of tactile stimulus, according to the present invention.

FIG. 19 is a view for explaining operations of an acoustic displayer, according to the present invention.

FIG. 20 is a view illustrating a principle of operations of a tactile-sense input/output dial, according to the present invention.

FIG. 21 is a view illustrating a procedure of operations of a tactile-sense input/output dial, according to the present invention.

FIG. 22 is a view illustrating an example of a pen-type interface for reproducing a feeling of pushing a button, according to the present invention.

### BEST MODE FOR CARRYING OUT THE INVENTION

Hereinafter, embodiments of the present invention will be described in detail with reference to the accompanying drawings so that the ordinarily skilled in the art can easily implement the embodiments. However, in the detailed description of operational principles of the embodiments of the present invention, detailed description of well-known construction and operations will be omitted for clarifying the present invention.

In addition, in the drawings, elements having similar functions and operations are denoted by the same reference numerals.

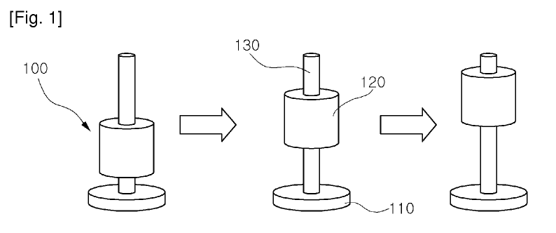

FIG. 1 is a view for explaining a principle of a linear actuator used for the present invention.

The linear actuator 100 according to the present invention includes a transducer 110 which generates a fine displacement according to an electrical signal, a moving shaft 130 which is vertically connected to the transducer 110 to perform a fine vertical movement according to the fine displacement of the transducer 110, and a moving member 120 which is formed in a shape of surrounding the moving shaft 130 to move together with the moving shaft 130 or in separation from the moving shaft 130 according to a speed of the fine vertical movement of the moving shaft 130.

The transducer 110 is formed in a bimorph disk shape to be changed concavely or convexly according to the electrical signal. In addition, the transducer 110 is made of a piezoelectric material which rapidly responds to a potential difference of the electrical signal to generate a displacement.

In the linear actuator 100 having the aforementioned construction, the moving shaft 130 and the moving member 120 performs the following movements according to the electrical signal applied to the transducer 110.

Firstly, the transducer 110 generates a displacement, that is, a fine movement in which the transducer 110 is changed concavely or convexly according to the applied electrical signal. Due to the fine movement of the transducer 110, the moving shaft 130 vertically connected thereto performs a fine vertical reciprocating motion. At this time, the moving member 120 surrounding the moving shaft 130 exerts a pre-determined frictional force to the moving shaft 130, so that the moving member 120 moves together with the moving shaft 130 or in separation from the moving shaft 130 according to the moving speed of moving shaft 130.

If the moving speed of the moving shaft 130 is slow, the moving member 120 moves together with the moving shaft 130 due to the frictional force to the moving shaft 130. If the moving speed of the moving shaft 130 is enough high for the moving shaft 130 to move instantaneously, sliding occurs between the moving member 120 and the moving shaft 130, so that the moving member 120 moves in separation from the moving shaft 130.

The ultrasonic linear actuator 100 to which the moving shaft 130 is fixed can finely change a position of the moving member due to the instantaneous movement of the transducer 120 using the aforementioned principle. In general, since the changing amount is less than several micrometers, the changing amount cannot be perceived with a human eye. However, since the transducer 110 is typically made of a piezo-electric material (piezoelectric ceramic, piezoelectric polymer, etc) which can rapidly responds to an electrical signal, the transducer 110 can be operated with a frequency of tens kHz or more. Therefore, in a case where the transducer 110 is operated with a high frequency, the moving member 120 can be moved in a desired direction at a moving speed of tens mm/sec or more.

An audible frequency of a human is about 20 kHz in maximum. If the transducer 110 is operated at a frequency higher than the audible frequency, the transducer 100 outputs an ultrasonic sound that is not audible to the human. As the most representative one, there is an ultrasonic linear actuator. The ultrasonic actuator can be employed to various applications as well as the linear actuator. In the present invention, a linear actuator where a moving member 120 is moved along the moving shaft 130 according to the aforementioned principle as shown in FIG. 1 is exemplified. The linear actuator does not almost generate noise and can be implemented as an actuator having extremely compact size and with low power consumption. In addition, although the ultrasonic frequency is not used, the moving member 120 can be moved with slightly generated noise.

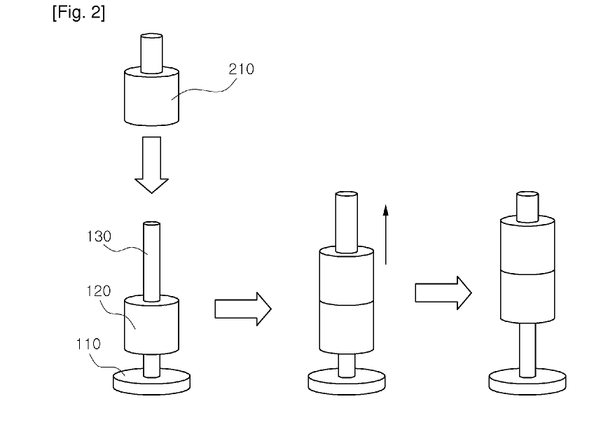

FIG. 2 is a view illustrating a method of attaching a pin-type tactile-sense transmitting portion to the linear actuator used for the present invention.

FIG. 2 illustrates an embodiment where a pin-type tactile-sense transmitting portion is attached to a skin contact portion of the linear actuator 100 so as to efficiently transmit a tactile sense. In order to represent braille dots or reproduce the tactile sense, a plurality of linear actuators are simultaneously used to directly stimulate a skin to transmit the tactile sense. In the linear actuator 100, a moving shaft 130 performs a fine vertical reciprocating motion due to a fine reciprocating motion of a transducer 100. When a speed of the reciprocating motion of the moving shaft 130 is higher than a pre-determined speed, sliding between the moving shaft 130 and the moving member 120 occurs, so that the moving member 120 move in separation from the moving shaft 130. In order to transmit the tactile sense to the contacting skin through the movement of the moving member 120, a tactile-sense transmitting portion 210 is provided to an upper surface of the moving member 120 in an integral shape or a separable shape. The tactile-sense transmitting portion 210 moves depending on the movement of the moving member 210. In a case where the tactile-sense transmitting portion 210 can be separated from the moving member 120, the tactile-sense transmitting portion may be modified or replaced in various shapes. For example, concave-convex portions may be formed on an upper surface of the tactile-sense transmitting portion 210 contacting with the skin, so that a strong stimulus is exerted on the skin. Alternatively, a spherical shape may be used to easily transmit the tactile sense.

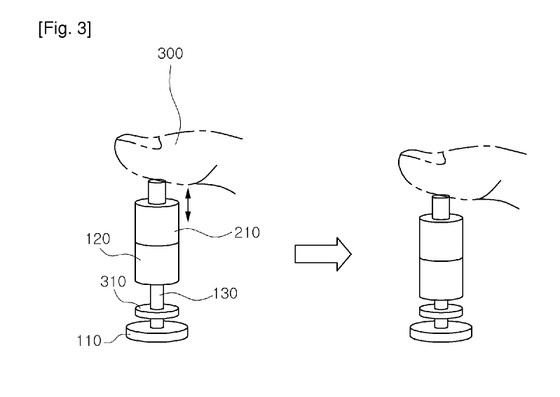

FIGS. 3 to 6 illustrate embodiments where the moving member 120 moves in separation from the moving shaft 130 due to the fine movement of the transducer 110 so as to input and output the tactile sense.

FIG. 3 is a view illustrating a first embodiment of a compact tactile-sense input/output motor attached with a sensor for sensing a tactile-sense input according to the present invention. Hereinafter, the compact tactile-sense input/output motor according to the present invention has the same meaning as a linear actuator for transmitting the tactile sense.

Referring to FIG. 3, the compact tactile-sense input/output motor includes a transducer 110 which generates a displacement according to an electrical signal, a moving shaft 130 which is connected to the transducer 100 to perform a vertical movement according to the displacement of the transducer 110, a moving member 120 which is formed in a shape of surrounding the moving shaft 130 to move according to the electrical signal, a tactile-sense transmitting portion 210 which is provided to an upper surface of the moving member 120 to transmit a tactile sense to a contact surface contacting with a skin according to the movement of the moving member and to transmit a pressure of the contact surface to the moving member 120 so as to move the moving member 120 downwards, and a contact sensor 310 which senses a contact of the downwardly-moving moving member 120 to output a tactile-sense input signal.

The compact tactile-sense input/output motor according to the present invention has a characteristic in that it can transmit the tactile sense to the skin 300 according to the applied electrical signal and sense the tactile sense corresponding to the pressure exerted from the skin 300 by using the contact sensor 310 to output the tactile-sense input signal.

In order to sense of the movement of the moving member 120 which move downwards according to the pressure exerted by pushing of the skin or finger 300, the contact sensor 310 may be provided to the moving shaft 130 in an integral shape or a separable space. In this case, the contact sensor 310 may be disposed to the moving shaft 130 between the transducer 110 and the moving member 120 or to an upper portion of the transducer 110. Therefore, when the tactile-sense transmitting portion 210 pushed by the finger 300 moves downwards together with the moving member 120 and contacts with the contact sensor 310, it can be sensed that there is a tactile-sense input to the skin. As the contact sensor 310, various sensor devices such a pressure sensor which can sense the contact of the moving member 120 can be used.

In case of outputting the tactile sense by using the compact tactile-sense input/output motor, a predetermined electrical signal is applied, and the moving member 120 moves according to the electrical signal. However, when the tactile-sense output is ended, the electrical signal is not applied, and the moving member 120 stops at a pre-determined position. In this case, a static frictional force between the moving member 120 and the moving shaft 130 or a force generated from the movement of the moving member 120 along the moving shaft 130 is designed to be less than 1N, so that the tactile-sense transmitting portion (sometimes, referred to as a pin) 210 can push the finger so as to transmit the tactile sense. Preferably, the static frictional force and the force generated from the movement of the moving shaft 130 are designed in a range of 0.1 to 0.5N. This is because the level of force corresponds to a force for deforming a skin by about 1 mm and a force for pushing a pin (that is, the tactile-sense transmitting portion 210) smoothly without a pain of the finger 300.

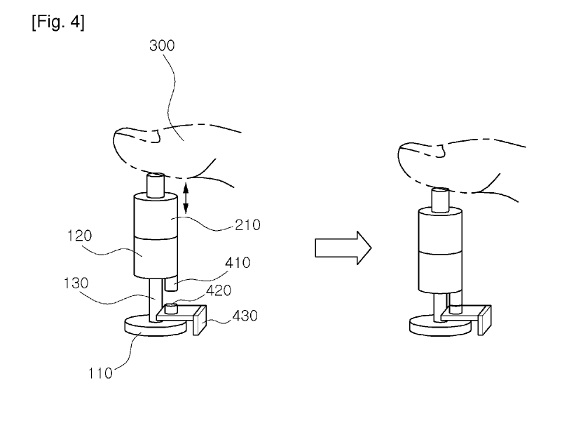

FIG. 4 is a view illustrating a second embodiment of a compact tactile-sense input/output motor attached with a sensor for sensing a tactile-sense input according to the present invention.

In the compact tactile-sense input/output motor shown in FIG. 4, the transducer 110, the moving member 120, the moving shaft 130, and the tactile-sense transmitting portion 210 are the same as those of the compact tactile-sense input/output motor shown in FIG. 3, and thus, detailed description thereof is omitted. However, a shape of the sensor for sensing the pressure exerted on the skin 300 is different therebetween.

The contact sensor 420 shown in FIG. 4 is not fixed to the transducer 110 or the moving shaft 130, but disposed to a fixing portion 430. The fixing portion 430 is fixed to not the compact tactile-sense input/output motor but another portion so as to support the contact sensor 420.

In addition, a pin-type contact portion 410 may be provided to a lower surface of the moving member 120. Although the contact portion 410 is not always needed, the contact portion may be provided if needed.

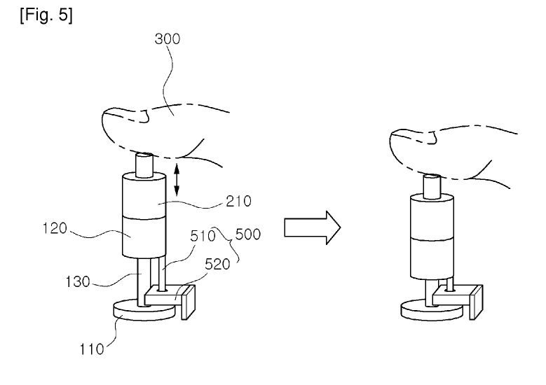

FIG. 5 is a view illustrating a third embodiment of a compact tactile-sense input/output motor attached with a sensor for sensing a tactile-sense input according to the present invention.

In the embodiment shown in FIG. 5, a displacement measurement sensor 500 is used as a sensor for sensing the tactile-sense input/output. The displacement measurement sensor 500 includes a moving pin 510 which is connected to a lower portion of the moving member 120 to move according to the movement of the moving member 120 and an electricity inducing unit which senses a tactile-sense input according to a change in current or voltage generated due to the movement of the moving pin 510 and outputs an input signal. As the displacement measurement sensor 500, a linear variable differential transformer (LVDT), a Hall sensor, a magnetic sensor, and the like may be used.

In case of using the displacement measurement sensor 500, unlike the embodiment shown in FIGS. 3 and 4, since the movement of the moving member 120 can be accurately measured, a depth of push of the finger can be accurately measured. In addition, the currently moving position of the moving pin 520 can be measured, so that more accurate tactile-sense input/output can be implemented. Particularly, although the position of the moving member 120 is changed due to the pushing of the finger or an external force, the moving member 120 can be restored to its original position.

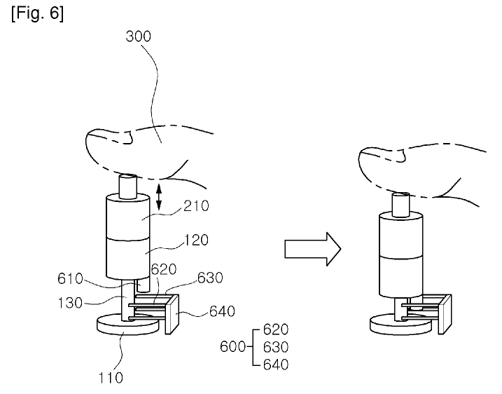

FIG. 6 is a view illustrating a fourth embodiment of a compact tactile-sense input/output motor attached with a sensor for sensing a tactile-sense input according to the present invention.

In the embodiment shown in FIG. 6, an optical sensor 600 capable of measuring the movement of the moving member stepwise is used to measure the tactile-sense input/output. The optical sensor 600 senses the tactile-sense input by using light. The optical sensor 600 includes a light-emitting unit 620 for emitting light and a light-receiving unit 630 for sensing a change in the light emitted by the light-emitting unit 620 due to the movement of the moving pin 610 and outputting the tactile-sense input signal. The light-emitting unit 620 and the light-receiving unit 630 are fixed to a fixing portion 640 which is fixed to an external portion of the motor. The light-emitting unit 620 and the light-receiving unit 630 sense a position of a moving pin 610 attached to a lower portion of the moving member 120 so as to determine whether or not a tactile-sense input of the skin exits.

The sensing of the tactile-sense input by using the optical sensor 600 is performed as follows. When a pressure of the skin or the finger is exerted to the tactile-sense transmitting portion 210, the moving pin 610 attached to the lower portion of the moving member 120 moves downwards. When the downwardly-moving moving pin 610 passes between the light-emitting unit 620 and the light-receiving unit 630, the moving pin 610 blocks the light emitted by the light-emitting unit 620. Therefore, according to the light received by the light-receiving unit 630, the moving dis-placement of the moving pin 610 can be sensed.

In addition, a plurality of the optical sensors 600 each of which includes a pair of the light-emitting unit and the light-receiving unit may be disposed vertically. In this case, the movement of the moving member 120 can be measured stepwise. Therefore, if the moving pin 610 moved by the pressure of the skin 300 approaches a pre-determined height, it is determined that the tactile-sense input exists.

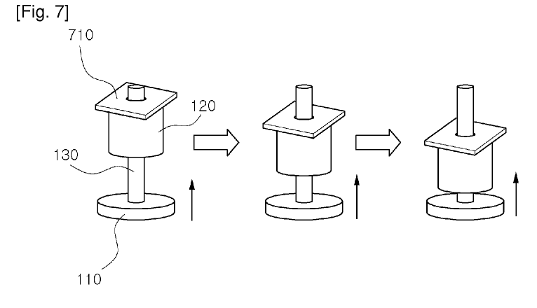

FIGS. 7 to 9 illustrate embodiments where a moving member is fixed and a moving shaft moves vertically according to a fine movement of a transducer.

FIG. 7 is a view illustrating a concept of inputting a tactile sense by using a moving shaft according to the present invention.

In general, in an ultrasonic actuator or a compact tactile-sense input/output motor, the moving shaft 130 is fixed, and a moving member 120 is moved. However, by employing the operational principle of the ultrasonic actuator shown in FIG. 1, if the moving member 120 is fixed, the moving shaft 130 can perform a linear motion.

The moving member 120 is fixed to a fixing plate 710 without movement, and the moving shaft 130 is vertically moved according to an electrical signal applied to the transducer 110. Therefore, the tactile sense of the skin can be input and output according to the vertical movement of the moving shaft 130. Accordingly, a separate component such as the aforementioned tactile-sense transmitting portion is not needed for the moving member 120. In order to improve an efficiency of the tactile sense transmitting, a treatment for stimulating the skin may be performed on an upper end of the moving shaft 120.

The moving member 120 may be fixed to a cover 710 of an apparatus employing the tactile-sense input/output motor or another fixing portion thereof so as to input and output the tactile sense. Accordingly, a pin array for stimulating the skin can be further miniaturized, and a production process thereof can be simplified.

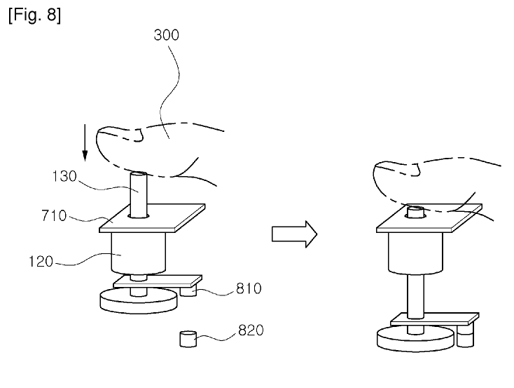

FIG. 8 is a view illustrating a first embodiment of a compact tactile-sense input/output motor of inputting and outputting a tactile sense by using a moving shaft according to the present invention.

In the compact tactile-sense input/output motor shown in FIG. 8, the tactile sense is transmitted to the skin due to the movement of the moving shaft 120. A fine dis-placement of the moving shaft 130 is generated according to a displacement of the transducer 110, which is generated according to an electrical signal applied to the transducer 110. Therefore, the moving shaft 130 is vertically moved with reference to the fixed moving member 120, so that the tactile sense can be transmitted to the skin contacting with the upper end of the moving shaft 130.

In a case where a pressure is exerted as the tactile-sense input from the skin 300 contacting with the upper end of the moving shaft 130, the moving shaft 130 is moved downwards. According to the downward movement of the moving shaft 130, a contact structure 810 connected to the moving shaft is also moved to contact with a contact sensor 820. As a result, the contact sensor 820 can sense the tactile-sense input.

The contact sensor 820 shown in FIG. 8 may be replaced with the dis-placement measurement sensor or the optical sensor shown in FIGS. 5 and 6.

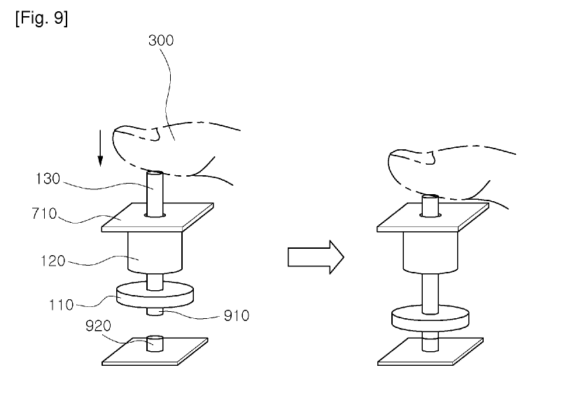

FIG. 9 is a view illustrating a second embodiment of a compact tactile-sense input/output motor of inputting and outputting a tactile sense by using a moving shaft according to the present invention.

In FIG. 9, the tactile-sense input is sensed by using a principle that the transducer 110 is moved simultaneously when the moving shaft 130 is moved. A contact portion 910 is attached to a lower surface of the transducer 110. A contact sensor 920 is fixed to another fixing portion to be separated by a predetermined distance from the transducer 110. Therefore, when a pushing force of a skin or a finger is exerted, the moving shaft 130 and the transducer 110 are moved downwards, so that the contact portion 910 attached to the transducer 110 contacts with the contact sensor 920. As a result, the contact sensor 920 can sense the tactile-sense input.

The contact sensor shown in FIG. 9 may also be replaced with the dis-placement measurement sensor or the optical sensor shown in FIGS. 5 and 6.

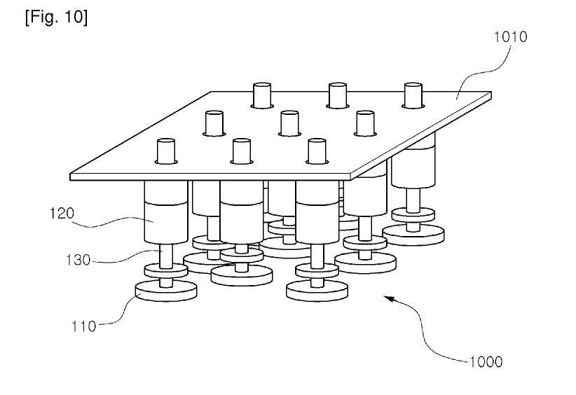

FIG. 10 is a view illustrating a construction of a tactile-sense input/output housing in which a plurality of compact tactile-sense input/output motors are arrayed uniformly, according to the present invention.

The tactile-sense input/output housing 1000 includes a plurality of the compact tactile-sense input/output motors that are described in the various embodiments. In order to use the tactile-sense input/output housing 1000 for various mobile terminals or the like, it is important to reduce a size thereof. In general, in an array of the tactile-sense input/output motors, it is difficult to design an interval between the motors to be smaller than a radius of the transducer 110. Therefore, according to the present invention, in order to reduce the interval, lengths of the adjacent moving shafts 130 are different from each other so that the tactile-sense input/output motors are arrayed in an overlapped form. In this manner, in case of arraying a plurality of the tactile-sense input/output motors, the individual motors can be used as buttons. In addition, according to the operations of the individual pins, various stimulating patterns can be generated, so that desired information in accordance with a predetermined rule can be transmitted as tactile-sense input and output

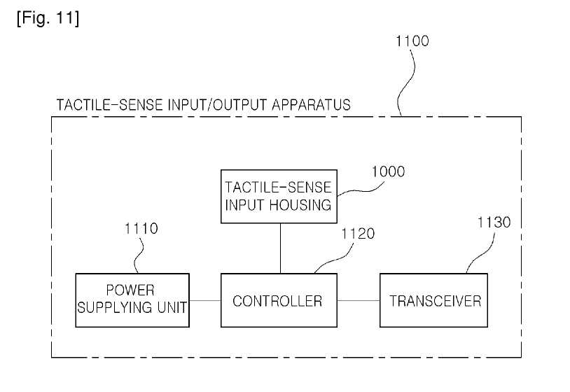

FIG. 11 is a view illustrating a construction of a tactile-sense input/output apparatus according to the present invention.

The tactile-sense input/output apparatus 1100 includes a tactile-sense input/output housing 1000 having a plurality of tactile-sense input/output motors, each of which performs a linear motion according to an ultrasonic electrical signal to transmit a tactile sense to a contact surface and senses a pressure of contact surface to output a tactile-sense input signal, a power supplying unit 1120 which supplies a power to the plurality of the tactile-sense input/output motors, a controller 1120 which controls the electrical signals input to the ultrasonic input/output motors and receives the tactile-sense input signals, and a transceiver 130 which receives the control signals for the tactile-sense input/output motors to transmit the control signals to the controller 1120 and transmits the tactile-sense input signal transmitted from the controller 1120.

As shown in FIG. 10, the tactile-sense input/output housing 1000 includes a plurality of the compact tactile-sense input/output motors which are arrayed in a pre-determined pattern. As the compact tactile-sense input/output motors, at least one type of the compact tactile-sense input/output motors shown in FIGS. 3 to 6, 8, and 9 can be used

The tactile-sense input/output housing 1000 controls the plurality of tactile-sense input/output motors according to the tactile-sense output signal input from the transceiver 1130 and the control signal transmitted from the controller 1120 so as to transmit the tactile sense to the contacting skin. The transmitted tactile sense contains various types of information, which are varied according to applications where the tactile-sense input/output apparatus 1100 is used. For example, the tactile-sense information may be used for representing braille dots for a blind person and as information for alarming emergency

The tactile-sense input/output housing 1000 can input the tactile-sense information by pushing the compact tactile-sense input/output motors by using the skin or finger as well as it can output the tactile-sense information. Each of the compact tactile-sense input/output motors transmits the tactile-sense input sensed through the pressure to the controller.

The power supplying unit 1110 supplies a power required to operate the tactile-sense input/output apparatus 110 to the tactile-sense input/output apparatus 1100. The power supplying unit 1100 supplies a power required to drive the compact tactile-sense input/output motors of the tactile-sense input/output housing 1000.

The controller 1120 controls the tactile-sense input/output housing 1000 by using the tactile-sense output information transmitted from the transceiver 1130. In addition, the controller receives the tactile-sense input signal sensed by the tactile-sense input/output housing 1000 and transmits the received tactile-sense input signal to the transceiver 1130.

In addition, the controller 1120 controls the whole operations of the tactile-sense input/output apparatus 1100.

The transceiver 1130 receives information that is to be transmitted to the skin and transmits the information to the controller 112. In addition, the transceiver 1130 receives the tactile-sense input signal transmitted from the controller 1120 and transmits the tactile-sense input signal.

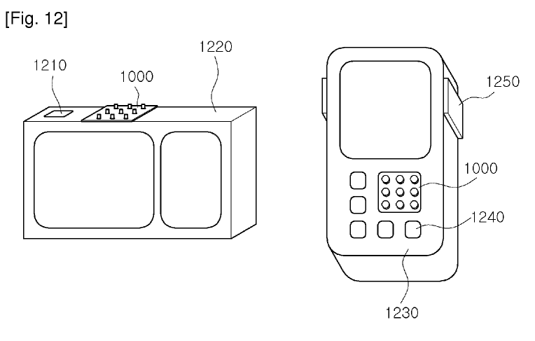

FIG. 12 is a view illustrating an embodiment of a tactile-sense input/output apparatus applied to a portable apparatus, according to the present invention.

As shown in FIG. 12, the tactile-sense input/output apparatus 1000 may be used as a substitute of all or a portion of manipulation buttons of a portable media player 1220 such as an MP3 player, a portable cassette player, and a portable video player. In this case, in order to efficiently manage a power of the tactile-sense input/output apparatus 1000, an external power manipulation key 1210 may be separately provided. In addition to functions as manipulation buttons, the tactile-sense input/output apparatus 1000 built in the portable media player 1220 can be used for transmitting operation states after the manipulation by using the tactile sense so as for a user to perceive the operation state by touching with hand without seeing through eyes.

In addition, the tactile-sense input/output apparatus 1000 may be used as a substitute of all or a portion of manipulation buttons of a mobile communication apparatus 1230 such as a mobile phone and a smart phone. The tactile-sense input/output apparatus 1000 may be disposed at number input position of the mobile phone or on the side portion 1250 with which a finger contacts when the mobile phone is grabbed with a hand. In this case, in order to efficiently manage a power of the tactile-sense input/output apparatus 1000, an external power manipulation key 1240 may be separately provided. In addition to functions as manipulation buttons, the tactile-sense input/output apparatus 1000 built in the portable communication apparatus 1230 can be used for transmitting operation states after the manipulation by using the tactile sense so as for a user to perceive the operation state by touching with hand without seeing through eyes. If needed, the tactile-sense input/output apparatus can be used in combination with a vibration motor built in the portable communication apparatus 1230 so as to transmit the tactile-sense information.

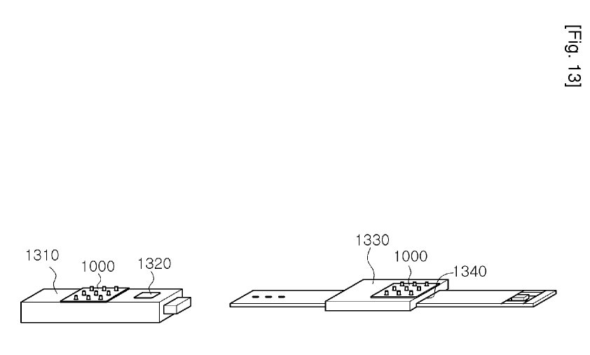

FIG. 13 is a view illustrating an embodiment of a tactile-sense input/output apparatus built in a remote controller or a wrist wearable device, according to the present invention.

AS shown in FIG. 13, the tactile-sense input/output apparatus 1000 may be built in a compact remote controller 1310 for various electronic products. In this case, in order to efficiently manage a power of the tactile-sense input/output apparatus 1000, an external power manipulation key 1320 may be separately provided. In addition to functions as manipulation buttons, the tactile-sense input/output apparatus 1000 can be used for transmitting operation states after the manipulation by using the tactile sense so as for a user to perceive the operation state by touching with hand without seeing through eyes.

As another embodiment of FIG. 13, the tactile-sense input/output apparatus 1000 may be built in a wrist-type apparatus 1330. In addition to functions as manipulation buttons, the tactile-sense input/output apparatus 1000 can be used for transmitting operation states after the manipulation by using the tactile sense so as for a user to perceive the operation state by touching with hand without seeing through eyes. In addition, the tactile-sense input/output apparatus 100 may be used for a wrist wearable device for a blind person or for transmitting information with security maintained at night. If needed, the tactile-sense input apparatus can be used in combination with a vibration motor built in the wrist-type apparatus 1330 so as to transmit the tactile-sense information. In this case, in order to efficiently manage a power of the tactile-sense input/output apparatus 1000, an external power manipulation key 1340 may be separately provided. The wrist-type apparatus 1330 includes all types of apparatus winding around, being fixed to, or being attached to the wrist.

In addition, in FIG. 13, since the tactile-sense input/output apparatus 1000 is disposed on an outer surface of the wrist-type apparatus 1330, a finger may be inconveniently moved to touch the tactile-sense input/output apparatus. In this case, the tactile-sense input/output apparatus 1000 is disposed on an inner surface of the wrist-type apparatus, that is, a portion of the wrist-type apparatus 1330 contacting with the wrist. Therefore, the operation state after manipulation can be more intuitively perceived.

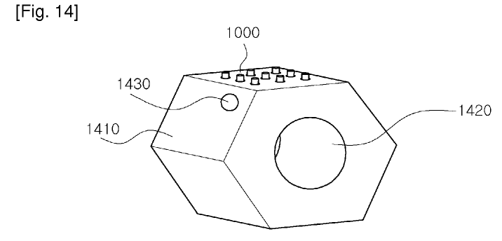

FIG. 14 is a view illustrating an embodiment of a tactile-sense input/output apparatus built in a ring, according to the present invention.

As shown in FIG. 14, the tactile-sense input/output apparatus 100 may be built in a ring having a hole 1420. The ring with compact tactile-sense input/output apparatus 1000 is put on an index finger, and the tactile-sense input/output apparatus 1000 provides an interface that a user can manipulates with a thumb. The finger on which the ring is put and the finger with which the user manipulates the tactile-sense input/output apparatus may be selected suitably for user's convenience of usage. However, the basic manipulation principle that the ring is put on one finger and the tactile-sense input/output apparatus is manipulated with another finger is not changed. Such a new interface serves as a compact keyboard, so that various predetermined characters or commands can be input with a feeling similar to a feeling of pushing real buttons. In addition, the tactile-sense input/output apparatus 1000 can be used for transmitting operation states after the manipulation by using the tactile sense so as for a user to perceive the operation state by touching with hand without seeing through eyes. For example, an operation command for a remote controlled apparatus is issued by using the tactile-sense input/output apparatus 1000 built in the ring. During the operation, the remote controlled apparatus transmits a signal to the ring. A specific tactile stimulus is generated from the tactile-sense input/output apparatus, so that successful operation can be perceived. In a case where a current state of the remote controlled apparatus needs to be checked, when a current-state checking button is manipulated, the operation state of the apparatus is transmitted to the ring, so that the current state can be checked.

In addition, an interface having the tactile-sense input/output apparatus 1000 can be used as a substitute for a mouse of a computer, so that motions or clicks of the mouse can be replaced with manipulation of the buttons. In addition, the interface may be used as a user's interface for controlling various apparatuses.

In FIG. 14, since the tactile-sense input/output apparatus 1000 is disposed on an outer surface of the ring 1410, a finger is move to touch the tactile-sense input/output apparatus so as to sense the tactile sense. In some cases, the tactile-sense input/output apparatus 1000 may be disposed on an inner surface of the ring, that is, a portion contacting a finger which the ring is put on. Therefore, the operation state after manipulation can be more intuitively perceived.

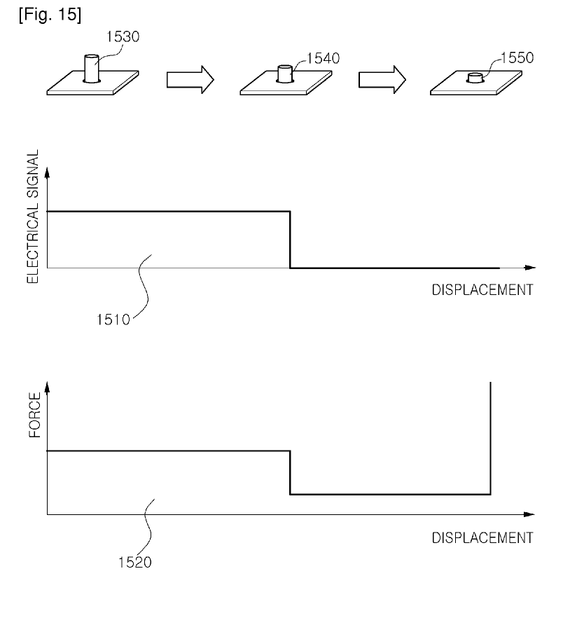

FIG. 15 is a view illustrating a method of inputting a tactile sense for inputting information while feeling the tactile sense, according to the present invention.

As shown in FIG. 15, a motor of the tactile-sense input/output apparatus 1000 is in an initial state that a tactile-sense transmitting portion (hereinafter, referred to as a pin) is protruded from a surface before the pin is pushed (1530). At this time, the motor is continuously applied with an electrical signal (voltage or current). When a user pushes the protruding pin of the motor, the pin is moved downwards. During the downward moving of the pin, the constant electrical signal is applied to the motor, so that the pine continuously pushes the finger with a constant force. If a sensor measuring a moving displacement of the pin senses that the pin approaches a middle step, the applying of the electrical signal is stopped (1540), so that the force exerted to the pin is lowered down to a level of a frictional force between a moving member and a moving shaft. If the pin is moved downwards to one lowered step, the pin approaches a mechanical limit (1550). Therefore, the pin is not further pushed, so that the pushing force is greatly increased. Since the operation proceed for a very short time, the user has a feeling of pushing a real button during the pushing of one pin of motor.

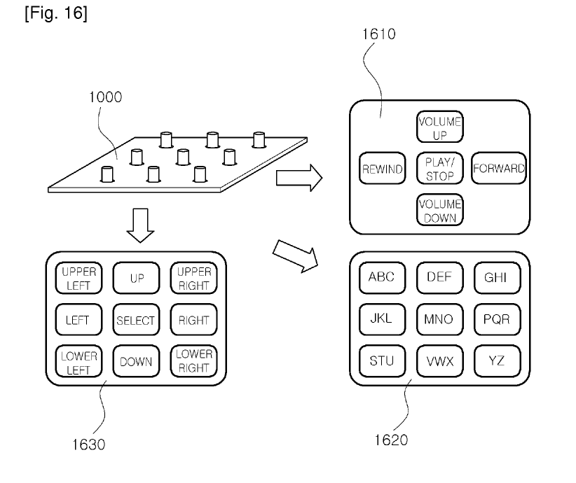

FIG. 16 is a view illustrating a method of using a tactile-sense input/output housing as a plurality of input buttons, according to the present invention.

As shown in FIG. 16, individual pins of the tactile-sense input/output apparatus can be operated like individual buttons described with reference to FIG. 14. For example, as shown in FIG. 16, in a case where 9 pins are arrayed in a 3×3 matrix, the pins can be used as manipulation buttons 1610 of a media player. The central button may be used for “Play and Stop”, the right button may be used for “Forward or Next Music”, the left button may be used for “Rewind or Last Music”, the upper button may be used for “Volume Up”, and the lower button may be used for “Volume Down”.

In addition, the tactile-sense input/output apparatus can be used as a keypad 1620 for input characters. In addition, the tactile-sense input/output apparatus can be used as a direction input unit 1630 through which computers or various electronic products can be manipulated.

In this case, since the individual pins may interrupt motion of fingers, a skin-contacting portion of each pin may be covered or treated with a thin vinyl, a plastic, or the like.

On the other hand, if a required mode is set, predetermined motors of the tactile-sense input/output apparatus are designed to be protruded. For example, in case of a mobile phone, if a game execution mode is set, motors corresponding to left, right, up, and down directional buttons required for a game among the tactile-sense input/output motors of the tactile-sense input/output apparatus are protruded.

In this manner, operations of protruding the motors required according to the mode settings can be employed to various electronic products using the tactile-sense input/output apparatus according to the present invention as an input/output apparatus. For example, the operations can be employed to a mobile phone, a remote controller, a ring, a bracelet, and the like.

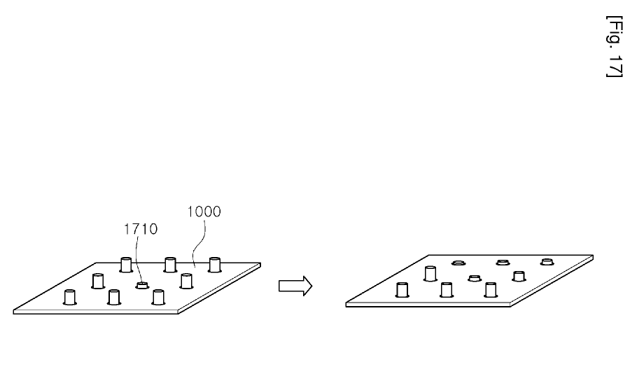

FIG. 17 is a view illustrating an example of employing a tactile-sense reproducing button, according to the present invention.

As described above with reference to FIG. 16, the tactile-sense input/output apparatus 1000 can be used as the manipulation buttons of the media player 1101. In this case, the tactile-sense input/output apparatus 100 can perform a function of checking an operation state after manipulation of the media player by using the tactile sense.

If the button 1710 of the tactile-sense input/output apparatus 1000 is pushed, the media player is operated. Conventionally, the operation state of the media player can be checked by seeing with eyes. However, according to the present invention, when the play button is pushed, the outer pins of the tactile-sense input/output apparatus 100 may be designed to be protruded in a circulation direction so as to represent the playing state. For example, during playing, the pins may be sequentially protruded and retrogressed clockwise. During reverse playing, the pins may be sequentially protruded and retrogressed in the opposite circulation direction, that is, counterclockwise.

In case of Next Music or Forward mode, the protruding and retrogressing of the pins are sequentially performed clockwise at faster speed. In case of Last Music or Rewinding mode, the protruding and retrogressing of the pins are sequentially performed counterclockwise at faster speed. Therefore, the user can perceive the current operation state by using the tactile sense at the same time of manipulation. In addition, in case of checking the current operation state, information can be notified by using the same method. The principle can be employed to various applications.

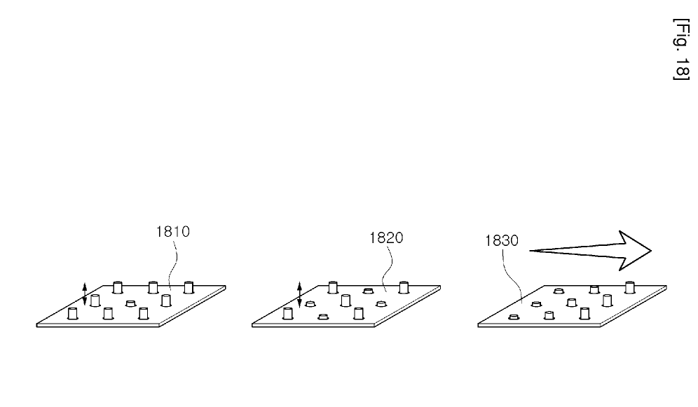

FIG. 18 is a view illustrating an output of tactile stimulus, according to the present invention.

The tactile-sense input/output apparatus 100 can transmit various types of information by using operation patterns of individual pins. An operation pattern 1810 can be used for transmitting affirmative information that current operation is normal and commands are well transmitted. In addition, information that a command is on execution can be represented by an operation pattern that the pins sequentially protrude to transmit tactile stimulus in circulation. In addition, information that the execution for the command is completed can be represented by an operation pattern that all the pins simultaneously sequentially protrude to transmit tactile stimulus. The operation pattern may be formed in a shape of a circle, a rectangle, or the like. The pins may be vertically moved to be fixed at some positions, so that the user can check the pattern by touching with hand. In addition, the pins may be vertically vibrated, so that the user can accurately the pattern by only the touching with hand. In this case, it is preferable that a frequency of the vertical vibration of pins is set to be in a range of 0.1 to 5 Hz or in a range of 20 to 40 Hz or less. This is because a neuro-transmitting path for sensing a pressure or a pattern is most sensitive in the range of 0.1 to 5 Hz and a neuro-transmitting path for sensing a pattern is sensitive in the range of 20 to 40 Hz. In this case, all the pins may be vertically moved to transmit a tactile-sense pattern. Alternatively, individual pins sequentially moved to transmit a pattern.

In addition, an X-shaped operation pattern 1820 can be used for transmitting negative information such as prohibition, stop, or a wrong command by using the tactile sense.

As shown in FIG. 18, an operation pattern 1730 that each column of pins in the tactile-sense input/output apparatus 1000 is simultaneously operated and the columns of pins are sequentially operated can be used for representing a wavelike shape. The operation pattern can be used as a tactile-sense pattern representing that the current command is on execution. In addition, the operation pattern may be used for representing moving direction such as leftward, rightward, forward, and backward according to a purpose. On the other hand, a normal-speed wave pattern may be used for the Play mode, a fast-speed wave pattern may be used for the Forward or Next Music mode, and a reverse wave pattern may be used for the Rewind or Last Music mode, so that various types of information can be transmitted by using the tactile sense.

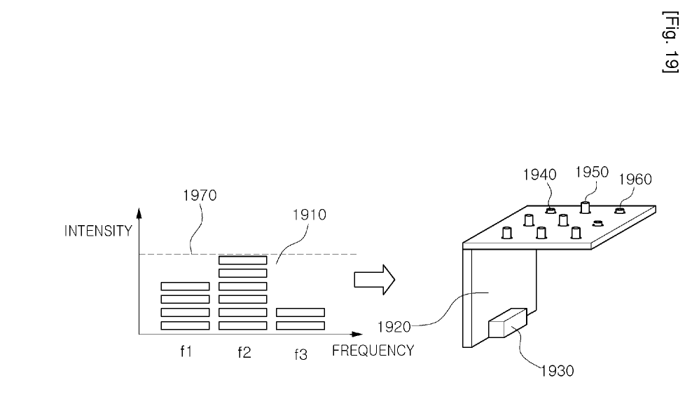

FIG. 19 is a view for explaining operations of an acoustic displayer, according to the present invention.

As shown in FIG. 9, acoustic characteristics of reproduced sounds can be represented with a tactile sense by using only the tactile-sense output function of the tactile-sense input/output apparatus. The acoustic characteristics of the sound source can be expressed with an intensity according to a frequency band. The intensity according to the frequency band can be expressed by using associated columns of the tactile-sense input/output apparatus and the number of associated columns. That is, a first frequency band f1 may correspond to a first column 1940 of a pin array, and a second frequency band f2 may correspond to a second column. In this manner, the frequency bands may be arranged to sequentially correspond to the columns of the pin array. In addition, a specific sound having a predetermined intensity or more may be reproduced by using a separate mechanism 1920 attached with a vibrator 1930.

In this manner, a music can be appreciated by using the tactile sense. Particularly, a deaf person can also appreciate a music by using the tactile sense.

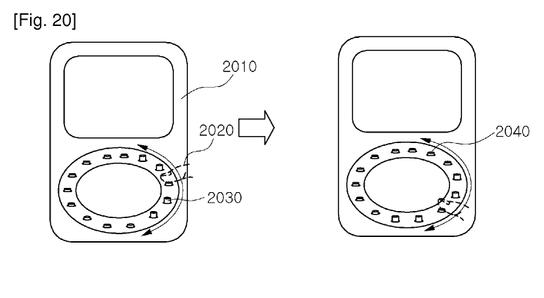

FIG. 20 is a view illustrating a principle of operations of a tactile-sense input/output dial, according to the present invention.

AS shown in FIG. 20, motors of the tactile-sense input/output apparatus are disposed in a shape of a circular dial on a phone. In the initial state, pins of tactile-sense input/output motors built in a dial shape in an apparatus 2101 are protruded slightly from a surface. When a pin is contacted with a finger 2020, the pin is pushed, so that a contact of the finger can be perceived. At the same time, one to three pins at both side of the pin are protruded. When a finger is moved along the dial, the pins are sequentially pushed, so that a tactile sense can be sensed. In addition, since the flowing pins are sequentially protruded, a feeling that the dial seems to be rotated with the finger can be represented by using the tactile sense. In this case, if the pins are exposed to transmit an abnormal feeling to a skin, upper portions of the pins may be covered with a thin vinyl or a plastic. Accordingly, a feeling that the dial is smoothly manipulated can be represented.

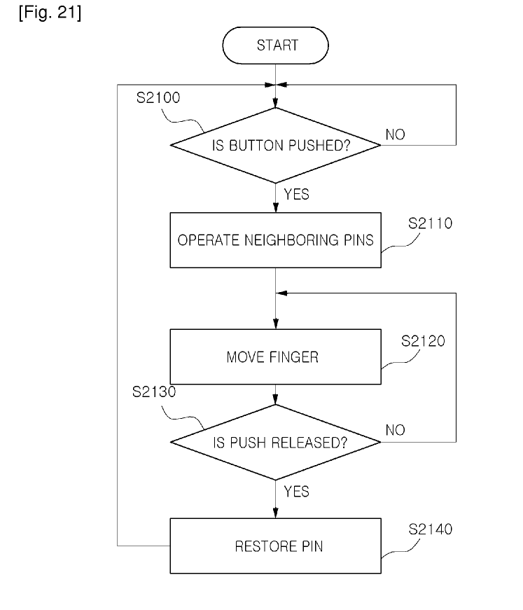

FIG. 21 is a view illustrating a procedure of operations of a tactile-sense input/output dial, according to the present invention.

As shown in FIG. 21, in the tactile-sense input/output dial 2040, all the pins have a button function and a tactile stimulator. In the initial state, all the pins are in a standby state for pushing. When a user pushes a pin with a finger (S2100), neighboring pins are protruded to be in the standby state (S2110). When the user starts rubbing with the finger, the finger leaves the pin (S2130), and the finger is restored to its original position (S2140). Next, a new pin is ready to receive a pushing signal.

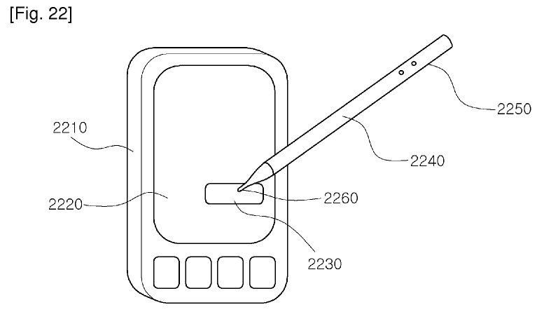

FIG. 22 is a view illustrating an example of a pen-type interface for reproducing a feeling of pushing a button, according to the present invention.

As shown in FIG. 22, a tactile-sense input/output motor 2260 is built in a stylus 2240, so that a feeling of pushing a button 2230 of a terminal 2210 with a touch screen 2220 can be realistically reproduced.

When the button on the touch screen is pushed with the stylus, a pin provided to a distal end of the stylus 2240 is retrogressed. When the pin is retrogressed to a pre-determined position, supplying of power is stopped, so that a feeling of pushing the button can be reproduced.

1. A compact tactile-sense input/output motor comprising:
a transducer which generates a displacement according to an electrical signal;
a moving shaft which is connected to the transducer to vertically move according to the displacement of the transducer;
a moving member which is formed in a shape of surrounding the moving shaft to move according to the electrical signal;
a tactile-sense transmitting portion which is provided to an upper surface of the moving member to transmit a tactile sense to a contact surface contacting with a skin according to the movement of the moving member and to transmit a pressure of the contact surface to the moving member so as to move the moving member downwards; and
a contact sensor which senses a contact of the downwardly-moving moving member to output a tactile-sense input signal.

2. The compact tactile-sense input/output motor of claim 1, wherein the electrical signal is an ultrasonic electrical signal, and the transducer is made of an piezo-electric material.

3. The compact tactile-sense input/output motor of claim 1, wherein the contact sensor is disposed to the moving shaft between the transducer and the moving member.

4. The compact tactile-sense input/output motor of claim 1, further comprising a contact portion which is formed to a lower surface of the moving member to transmit the movement of the moving member to the contact sensor.

5. A compact tactile-sense input/output motor comprising:
a transducer which generates a displacement according to an ultrasonic electrical signal;
a moving shaft which is connected to the transducer to perform a vertical fine reciprocating motion according to the displacement of the transducer;
a moving member which is formed to surround the moving shaft to vertically move according to the reciprocating motion of the moving shaft;
a tactile-sense transmitting portion which is provided to an upper surface of the moving member to transmit a tactile sense to a contact surface contacting with a skin according to the movement of the moving member and to transmit a pressure of the contact surface to the moving member so as to move the moving member downwards; and
a displacement measurement sensor which measures a moving displacement of the moving member according to the pressure and outputs a tactile-sense input signal if a predetermined moving displacement occurs.

6. The compact tactile-sense input/output motor of claim 5, wherein the displacement measurement sensor comprises:
a moving pin fixed on a lower surface of the moving member; and
an electricity inducing unit which outputs the tactile-sense input signal according to a change in current and voltage generated according to the moving displacement of the moving pin.

7. A compact tactile-sense input/output motor comprising:
a transducer which generates a displacement according to an electrical signal;
a moving shaft which is connected to the transducer to vertically move according to the displacement of the transducer;
a moving member which is formed in a shape of surrounding the moving shaft to move according to the electrical signal;
a tactile-sense transmitting portion which is provided to an upper surface of the moving member to transmit a tactile sense to a contact surface contacting with a skin according to the movement of the moving member and to transmit a pressure of the contact surface to the moving member so as to move the moving member downwards; and
an optical sensor which measures a moving displacement of a moving pin fixed on a lower surface of the moving member by using a light and outputs a tactile-sense input signal.

8. The compact tactile-sense input/output motor of claim 7, wherein the optical sensor comprises:
a light-emitting unit which emits a light; and
a light-receiving unit which senses a change of the light emitted by the light-emitting unit according to the moving displacement of the moving pin to output the tactile-sense input signal.

9. A compact tactile-sense input/output motor comprising:
a transducer which generates a displacement according to an electrical signal;
a moving shaft which is connected to the transducer to perform a vertical movement according to the displacement of the transducer to transmit a tactile sense to a contact surface contacting with a skin and to move downwards according to the a pressure of the contact surface;
a moving member which is formed to surround the moving shaft and fixed on the contact surface contacting with the skin; and
a sensor which measures a moving displacement of the moving shaft according to the pressure and outputs a tactile-sense input signal if a predetermined moving displacement occurs.

10. The compact tactile-sense input/output motor of claim 9, wherein the sensor senses a contact of the transducer moving downwards according to the movement of the moving shaft according to the pressure and outputs the tactile-sense input signal.

11. The compact tactile-sense input/output motor of claim 9, wherein the sensor outputs the tactile-sense input signal when the contact is sensed according to the downward movement of the moving pin connected to the moving shaft.

12. A tactile-sense input/output apparatus comprising:
a tactile-sense input/output housing having a plurality of tactile-sense input/output motors, each of which performs a linear motion according to an ultrasonic electrical signal to transmit a tactile sense to a contact surface and senses a pressure of the contact surface to output a tactile-sense input signal;
a power supplying unit which supplies a power to the plurality of the tactile-sense input/output motors;
a controller which controls the electrical signals input to the ultrasonic input/output motors and receives the tactile-sense input signals; and
a transceiver which receives the control signals for the tactile-sense input/output motors to transmit the control signals to the controller and transmits the tactile-sense input signal.

13. The tactile-sense input/output apparatus of claim 12, wherein the tactile-sense input/output motor comprises:
a transducer which generates a displacement according to an electrical signal;
a moving shaft which is connected to the transducer to vertically move according to the displacement of the transducer;
a moving member which is formed in a shape of surrounding the moving shaft to move according to the electrical signal;
a tactile-sense transmitting portion which is provided to an upper surface of the moving member to transmit a tactile sense to a contact surface contacting with a skin according to the movement of the moving member and to transmit a pressure of the contact surface to the moving member so as to move the moving member downwards; and
a contact sensor which senses a contact of the downwardly-moving moving member to output a tactile-sense input signal.

14. The tactile-sense input/output apparatus of claim 12, wherein the tactile-sense input/output motor comprises:
a transducer which generates a displacement according to an ultrasonic electrical signal;
a moving shaft which is connected to the transducer to perform a vertical fine reciprocating motion according to the displacement of the transducer;
a moving member which is formed to surround the moving shaft to vertically move according to the reciprocating motion of the moving shaft;
a tactile-sense transmitting portion which is provided to an upper surface of the moving member to transmit a tactile sense to a contact surface contacting with a skin according to the movement of the moving member and to transmit a pressure of the contact surface to the moving member so as to move the moving member downwards; and
a displacement measurement sensor which measures a moving displacement of the moving member according to the pressure and outputs a tactile-sense input signal if a predetermined moving displacement occurs.

15. The tactile-sense input/output apparatus of claim 12, wherein the tactile-sense input/output motor comprises:
a transducer which generates a displacement according to an electrical signal;
a moving shaft which is connected to the transducer to perform a vertical movement according to the displacement of the transducer to transmit a tactile sense to a contact surface contacting with a skin and to move downwards according to the a pressure of the contact surface;
a moving member which is formed to surround the moving shaft and fixed on the contact surface contacting with the skin; and
a sensor which measures a moving displacement of the moving shaft according to the pressure and outputs a tactile-sense input signal if a predetermined moving displacement occurs.

16. The tactile-sense input/output apparatus of claim 12, wherein, lengths of moving shafts of adjacent tactile-sense input/output motors are different from each other so that the tactile-sense input/output motors are arrayed in an overlapped form.

17. A mobile phone having the tactile-sense input/output apparatus of claim 12, the tactile-sense input/output apparatus being used for inputting and outputting a signal.

18. The mobile phone of claim 17, wherein at least one of the tactile-sense input/output motor corresponding to a function set by the mobile phone is moved upwards to be in a standby state.

19. The mobile phone of claim 17, wherein the mobile phone outputs a signal for checking an operation state of the mobile phone as a predetermined operation pattern according to information input through the tactile-sense input/output housing of the tactile-sense input/output apparatus.

20. The mobile phone of claim 19, wherein the operation state of the mobile phone is represented by sequentially protruding pins of the tactile-sense input/output motors of the tactile-sense input/output housing clockwise rotation, so that normal or abnormal operation state of the mobile phone can be checked.

21. The mobile phone of claim 17, wherein a plurality of tactile-sense input/output motors of the tactile-sense input/output apparatus are disposed in a shape of a circular dial on a surface of a mobile phone.

22. The mobile phone of claim 21, wherein, when contacting of one tactile-sense input/output motor of the tactile-sense input/output apparatus is sensed, the neighboring tactile-sense input/output motors are moved upwards.

23. A remote controller having the tactile-sense input/output apparatus of claim 12, the remote controller controlling an electronic product.

24. The remote controller of claim 21, wherein at least one of the tactile-sense input/output motors corresponding to a mode which is to be controlled by the remote controller are moved upward to be in a standby state.

25. A ring having the tactile-sense input/output apparatus of claim 12, the tactile-sense input/output apparatus being used for inputting and outputting a signal.

26. The mobile phone of claim 21, wherein a plurality of tactile-sense input/output motors of the tactile-sense input/output apparatus are provided to an inner surface of the ring so that a tactile sense is directly transmitted to a finger which the ring is put on.

27. A wrist-type apparatus having the tactile-sense input/output apparatus of claim 12, the tactile-sense input/output apparatus being used for inputting and outputting a signal.

28. An acoustic displayer having the tactile-sense input/output apparatus of claim 12, wherein tactile-sense input/output motors are driven according to pre-determined frequency bands corresponding to characteristics of reproducing sounds.

29. The acoustic displayer of claim 21, wherein a sound of which frequency band is higher than a predetermined frequency is transmitted as tactile-sense information by using a separate vibrator.

30. A method of inputting and outputting a tactile sense in a tactile-sense input/output motor which performs a linear motion according to an ultrasonic electrical signal to transmit a tactile sense to a contact surface and senses a pressure of the contact surface to output a tactile-sense input signal, the method comprising:
providing an electrical signal to the tactile-sense input/output motor;
measuring a movement of a moving shaft of the tactile-sense input/output motor, the movement being generated by the transmitted pressure;
stopping providing of the electrical signal when the moving shaft is moved to a predetermined position; and
outputting the tactile-sense input signal when the moving shaft contacts with a sensor of the tactile-sense input/output motor.
